(19) United States
(12) Patent Application Publication
(10) Pub. No.: US 2014/0259825 A1
(43) Pub. Date: Sep. 18, 2014

(54) PIPE ACCESSORY MOUNTING APPARATUS AND METHODS OF USE

(71) Applicant: Cristob Galvan, Orange, CA (US)

(72) Inventor: Cristob Galvan, Orange, CA (US)

(21) Appl. No.: 13/845,090

(22) Filed: Mar. 18, 2013

(51) Int. Cl. G09F 21/04; G09F 13/00

(52) U.S. Cl. CPC G09F 21/04; G09F 13/00
USPC 40/541; 40/591; 224/488

(57) ABSTRACT

A pipe accessory mounting apparatus for removable engagement with a substantially horizontally-oriented pipe provides, in at least one embodiment, a display wall and a heat wall substantially linearly aligned with and spaced apart from the display wall. The heat wall is configured for being selectively positioned a distance behind an end of the pipe, in a position between the pipe end and the display wall. An at least one elongate support arm is engaged proximally with each of the heat wall and display wall and configured for being removably secured distally against an outer wall of the pipe. A front surface of the display wall is configured for providing a visual display. During use, where the apparatus is engaged with an exhaust pipe, for example, the heat wall is capable of absorbing and deflecting any hot air emitted from the pipe end, allowing the display to remain substantially unaffected.

### RELATED APPLICATIONS

Not applicable.

### INCORPORATION BY REFERENCE

Applicant hereby incorporates herein by reference any and all U.S. patents and U.S. patent applications cited or referred to in this application.

### BACKGROUND OF THE INVENTION

1. Field of the Invention

Aspects of this invention relate generally to motor vehicle accessories, and more particularly to a pipe accessory mounting apparatus, and associated methods of use, configured for engagement with a substantially horizontally-oriented pipe for displaying an ornamental design or the like.

2. Description of Related Art

By way of background, people have been adorning their motor vehicles with various types of ornamentation for decades, so as to both customize the appearance of their vehicles as well as express their own personalities and/or personal interests. Aside from the relatively more permanent types of ornamentation—such as after-market body parts or custom paint jobs—there exists a wide range of relatively less permanent ornamentation options, including but not limited to, bumper stickers, window decals, antenna ornaments, rear-view window ornaments, and window banners and flags. Through these various types of ornamentation, people are essentially able to accessorize nearly every part of their vehicles.

In recent years, certain devices have even been developed to allow customization of a vehicle's exhaust pipe. However, as explained further below, due to the relatively high levels of heat emitted by a vehicle's exhaust pipe (typically in the range of 180 degrees to 300 degrees Fahrenheit), material and design options have been limited to those capable of withstanding such high temperatures and being located either on the outer surface of the exhaust pipe or—if within the pipe—configured such that the exhaust air is allowed to pass through the design.

The following art defines the present state of this field:

U.S. Pat. No. 1,447,749 to Beselin is generally directed to an advertising device for motor vehicles comprising an advertising body shaped to the configuration of an article to be smoked and adapted to be mounted upon an automobile, a conduit leading from the advertising body and secured to the vehicle, means carried by the advertising body for diffusing smoke and gases from the pipe, and a flexible coupling between said pipe and the exhaust portion of the automobile for permitting relative movements between the exhaust portion and the pipe during travel of the vehicle and for transmitting the exhaust smoke and gases to the advertising body.

U.S. Pat. No. 5,508,478 to Barry is generally directed to a visible flame exhaust pipe for use with internal combustion engines. A high temperature resistant glass is incorporated within the exhaust system to allow visibility of combustion flames passing through the exhaust pipe as the flame exits the exhaust system.

U.S. Pat. No. 6,623,134 to Chang is generally directed to a light-emitting structure of an automotive exhaust tailpipe that includes an outer tubular member which is fitted over the exhaust tailpipe and is provided with an inner tubular member fitted thereinto along with a first retaining member. A second retaining member is fitted over the inner tubular member such that a receiving space is formed between the first retaining member and a second retaining member for receiving a heat-resistant piece. The second retaining member is provided with a plurality of light bulb sockets. The automotive exhaust tailpipe is thus provided with a light-emitting effect to reinforce the warning effect of the tail lights of the motor vehicle.

U.S. Pat. No. 6,471,377 to Stegall is generally directed to an illuminated exhaust tail pipe assembly that can readily be attached to an existing vehicle exhaust system, comprising a connector end section secured to the existing exhaust system; an internal pipe assembly secured at one end to the connector end section; an external pipe assembly connected at an inner end to the connector end section and mounted about an enclosing a major portion of the internal pipe assembly; and an illuminated light assembly having at least one light bulb member mounted therein to provide a lighted area between an outer surface of the internal pipe assembly and an inner surface of the external pipe assembly. The external pipe assembly, at an inner end thereof, is provided with a plurality of air coolant holes and a light receiving opening. The air coolant holes can be equally spaced thereabout being of a number and size to provide the desired amount of coolant air to flow about an outer surface of the internal pipe assembly to achieve a coolant effect on the exhaust gases. The light receiving opening is adapted to receive a light bulb member therein and being activated through a tail light switch member to achieve illumination thereof when the normal tail light members on a vehicle are energized when darkness approaches.

U.S. Patent Application Publication No. 2005/0061571 to Chen is generally directed to a tail pipe of an automotive exhaust system that includes an ornamental element bearing or in the form of a symbol located at or near an outer end through which exhaust gas exits. The ornamental element is sized to provide a sufficient space to allow the exhaust gas to flow substantially unimpeded past the ornamental element.

U.S. Patent Application Publication No. 2005/0167191 to Miller is generally directed to a decorative attachment for a tailpipe. The invention comprises a cylindrical member for attachment to the tailpipe of a vehicle and having an ornamental design across its span and the ornamental design may comprise a geometric shape or that of a figure such as an eagle or flag. The design may include a reflective material.

U.S. Patent Application Publication No. 2012/0024410 to Riley is generally directed to a tailpipe tip for inserting into a tailpipe opening comprising a perimeter, where said perimeter fits into the tailpipe opening; an etched design within the perimeter, where said design allows for the movement of air there through; and a means to attach the tip to the tailpipe opening. In one exemplary embodiment, the means to attach includes bolts.

The prior art described above teaches various types of exhaust pipe accessories, but fails to teach a pipe accessory mounting apparatus capable of removable engagement with a wide range of vehicle exhaust pipes and selective positioning of a visual display directly in the line of emitted exhaust air without damaging the display, regardless of the display materials or dimensions. Aspects of the present invention fulfill these needs and provide further related advantages as described in the following summary.

### SUMMARY OF THE INVENTION

Aspects of the present invention teach certain benefits in construction and use which give rise to the exemplary advantages described below.

The present invention solves the problems described above by providing a pipe accessory mounting apparatus for removable engagement with a substantially horizontally-oriented pipe. The apparatus provides, in the exemplary embodiment a display wall and a heat wall substantially linearly aligned with and spaced a distance apart from the display wall. The heat wall is configured for being selectively positioned a distance behind an end of the pipe, in a position between the pipe end and the display wall. An at least one elongate support arm is engaged proximally with each of the heat wall and display wall and configured for being removably secured distally against an outer wall of the pipe. A front surface of the display wall, facing substantially away from the pipe end, is configured for providing a visual display. Thus, during use, where the apparatus is engaged with an exhaust pipe, for example, the heat wall is capable of absorbing and deflecting any hot air that may be emitted from the pipe end, thereby allowing the display to remain substantially unaffected by said heat.

A primary objective inherent in the above described apparatus and method of use is to provide advantages not taught by the prior art.

Another objective is to provide such an apparatus that is capable of removable engagement with a wide range of substantially horizontally-oriented structures, including exhaust pipes.

Another objective is to provide such an apparatus that is capable of selectively positioning a visual display directly in the line of emitted exhaust air without damaging the display, regardless of the display materials or dimensions.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary pipe accessory mounting apparatus, in accordance with at least one embodiment;

FIG. 2 is a side elevational view thereof, in accordance with at least one embodiment;

FIG. 3 is a perspective view of the apparatus as removably engaged with an exhaust pipe, in accordance with at least one embodiment;

FIG. 4 is a perspective view of the apparatus, illustrating an alternate display wall of the apparatus, in accordance with at least one embodiment;

FIG. 5 is a perspective view of the apparatus as removably engaged with an exhaust pipe of a vehicle, in accordance with at least one embodiment; and

FIG. 6 is a perspective view of the apparatus as removably engaged with a trailer hitch receiver tube of a vehicle, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION OF THE INVENTION

The above described drawing figures illustrate aspects of the invention in at least one of its exemplary embodiments, which are further defined in detail in the following description.

Turning now to FIG. 1, there is shown a perspective view of an exemplary embodiment of a pipe accessory mounting apparatus 20. For illustrative purposes, the apparatus 20 will be herein described primarily in the context of exhaust pipes. However, it should be noted that the apparatus 20 should not be read as being so limited. In fact, the apparatus 20 can be used in connection with virtually any type of substantially horizontally-oriented rod, pipe or similar structures, now known or later developed, such as trailer hitch receiver tubes (FIG. 6). Additionally, while such substantially horizontally-oriented structures are herein discussed in the context of motor vehicles (i.e., cars, trucks, vans, busses, motorcycles, scooters, etc.) for illustrative purposes, it should be noted that the apparatus 20 is certainly capable of being used in connection with any other type of substantially horizontally-oriented, non-vehicular structures, cylindrical or otherwise, now known or later developed.

As shown best in FIGS. 1 and 2, the apparatus 20 comprises, in at least one embodiment, a display wall 22 and a heat wall 24 substantially linearly aligned with and spaced a distance D1 apart from the display wall 22. The heat wall 24 is relatively flat and disc-shaped, in the exemplary embodiment, and configured for being selectively positioned a distance D2 behind a pipe end 26 of an exhaust pipe 28 of a vehicle 30—substantially in the path of air emitted from the exhaust pipe 28—in a position between the pipe end 26 and the display wall 22. In this way, the apparatus 20 does not inhibit the flow of air from the exhaust pipe 28. Additionally, the heat wall 24 is capable of absorbing and deflecting the hot exhaust air, thereby assisting to prevent the heat from being transferred to the display wall 22. In the exemplary embodiment, the distance D1 between the display wall 22 and heat wall 24 is between eight millimeters (8 mm) and twelve millimeters (12 mm), and the distance D2 between the pipe end 26 and the heat wall 24 is at least two inches (2″). However, in further embodiments, the respective distances D1 and D2 may be more or less, depending on the application for which the apparatus 20 is to be used. Additionally, in the exemplary embodiment, a diameter of the heat wall 24 is relatively larger than a diameter of the pipe end 26 for better deflecting the exhaust air. However, in further embodiments, the diameter of the heat wall 24 may be equal to or relatively smaller than the diameter of the pipe end 26. In still further embodiments (not shown), the apparatus 20 provides an insulating material positioned between the heat wall 24 and display wall 22 for adding further heat protection for the display wall 22.

With continued reference to FIG. 2, in the exemplary embodiment, each of the heat wall 24 and display wall 22 is substantially vertically-oriented when positioned behind the pipe end 26 (FIG. 3). Additionally, in the exemplary embodiment, the heat wall 24 is substantially parallel with the display wall 22. However, in further embodiments, one or both of the heat wall 24 and display wall 22 may be angled (i.e., not vertically oriented) when positioned behind the pipe end 26, and may even be non-parallel with one another.

With continued reference to FIGS. 1 and 2, the apparatus 20 further comprises, in at least one embodiment, an at least one elongate, relatively flexible support arm 32 engaged with each of the heat wall 24 and display wall 22 and configured for being removably secured against an outer wall 34 of the exhaust pipe 28. In a bit more detail, a proximal end 36 of each support arm 32 is engaged with a rear surface 38 of the heat wall 24 as well as a rear surface 40 of the display wall 22, thereby rigidly maintaining the spaced-apart distance D1 between the heat wall 24 and display wall 22. As illustrated best in FIGS. 1 and 4, depending on the respective dimensions of each of the heat wall 24 and display wall 22, the proximal end 36 of each support arm 32 is bent appropriately so as to contact each rear surface 38 and 40. An opposing distal end 42 of each support arm 32 extends substantially perpendicularly away from the rear surfaces 38 and 40 and is configured for selectively contacting the outer wall 34 of the exhaust pipe 28. In the exemplary embodiment, the apparatus 20 provides three support arms 32 spaced apart from one another around a perimeter edge 44 of the heat wall 24; such an arrangement assisting to prevent the apparatus 20 from unintentionally moving or shifting on the exhaust pipe 28 during use. However, in further embodiments, the apparatus 20 may provide any number and/or arrangement of support arms 32. Additionally, given the relatively flexible quality of the support arms 32 in at least one embodiment, each of the support arms 32 is capable of bending for selectively adjusting the angle of the heat and display walls 24 and 22, relative to the exhaust pipe 28, as desired. In still further embodiments (not shown), the apparatus 20 may incorporate any other means, now known or later developed, for removably securing the heat wall 24 and display wall 22 to the outer wall 34 of the exhaust pipe 28, in a spaced-apart relationship with the pipe end 26.

As best shown in FIG. 3, in the exemplary embodiment, the support arms 32 are removably secured against the outer wall 34 of the exhaust pipe 28 by a circumferential clamp 46 that is capable of being selectively tightened about the outer wall 34 of the exhaust pipe 28, thereby sandwiching the distal end 42 of each support arm 32 therebetween. In such embodiments, the distal end 42 of each support arm 32 preferably provides an angled catch 48 configured for selectively contacting the clamp 46 and preventing the distal end 42 from completely sliding out from under the clamp 46, thereby maintaining the apparatus 20 on the exhaust pipe 28 so long as the clamp 46 is engaged therewith. Thus, depending on the respective lengths of the support arms 32, the distance D2 between the pipe end 26 and the heat and display walls 24 and 22 may be selectively adjusted by sliding more or less of the distal end 42 of each support arm 32 along a length of the outer wall 34 of the exhaust pipe 28, through the clamp 46, before tightening the clamp 46 against the outer wall 34 of the exhaust pipe 28. Given the structural qualities of each of the support arms 32 and circumferential clamp 46, as described above in the exemplary embodiment, the apparatus 20 is capable of being removably secured to a wide range of exhaust pipe 28 dimensions, along with other substantially horizontally-oriented structures, now known or later developed; thereby essentially making the apparatus 20 one-size-fits-all (or at least one-size-fits-most). In still further embodiments (not shown), the apparatus 20 may incorporate any other means, now known or later developed, for removably securing the distal end 42 of the at least one support arm 32 to the outer wall 34 of the exhaust pipe 28.

With continued reference to FIG. 3, the display wall 22 is relatively flat and disc-shaped in the exemplary embodiment, similar to at least the exemplary heat wall 24—though, preferably relatively larger than the heat wall 24, at least in the exemplary embodiment. A front surface 50 of the display wall 22—opposite the rear surface 40 and facing substantially away from the path of air emitted from the exhaust pipe 28—is configured for providing a display 52, such as a message or graphic. In light of the relative position of the display 52 as facing substantially away from the path of air emitted from the exhaust pipe 28, combined with the heat wall 24 functioning to substantially absorb and deflect the hot exhaust air, the display 52 is capable of remaining substantially unaffected by the heat, despite its proximity to the exhaust pipe 28 and regardless of the materials of which the display 52 is constructed.

In the exemplary embodiment, the display wall 22 is circular-shaped. However, in an alternate embodiment, as shown in FIG. 4, an alternate display wall 54 is oval-shaped. In that regard, it should be noted that the sizes and shapes that the display wall 22 may take on are virtually limitless, such that the display walls 22 and 54 shown are to be understood as merely exemplary. In still further embodiments (not shown), the display wall 22 may take on a relatively more three-dimensional shape—such as a cube or sphere rather than a relatively flat disc—thereby providing additional surfaces on which further displays may be positioned.

With respect to the display 52 itself, while a relatively two-dimensional design is shown in the drawings for illustrative purposes, the possible designs that may be incorporated into the display 52—including content—should not be read as being so limited. In fact, the term “display” is intended to generally include any type of visual display, now known or later developed (including but not limited to two-dimensional artwork, three-dimensional artwork, lighting displays, etc.), capable of being appropriately affixed to the display wall 22 using any means now known or later developed (including but not limited to direct printing or painting, permanent or temporary adhesion, permanent or temporary fastening, etc.). Thus, in at least one embodiment, shown in FIG. 5, the front surface 50 of the display wall 22 is configured for simply allowing a sticker 56 or decal to be selectively affixed thereto. In other words, in such an embodiment, the apparatus 20 is capable of providing an alternative surface for affixing the sticker 56, thereby saving other areas of the vehicle 30 that tend to be relatively more susceptible to damage from stickers and the like—such as the body 58 or windows 60 of the vehicle 30. In further embodiments, where the display 52 is two-dimensional and permanently affixed to the front surface 50 of the display wall 22, such as through direct printing or permanent adhesion, a protective coating—composed of materials such as polyurethane or the like—may be applied overtop of the display 52 for further protecting it from the elements.

As mentioned above, the exemplary embodiment of the apparatus 20 is capable of being removably secured to a wide range of exhaust pipes 28 and other substantially horizontally-oriented structures, now known or later developed. With respect to vehicular structures, one such other structure is a trailer hitch receiver tube 62 of the vehicle 30, as illustrated in FIG. 6. Again, though, the apparatus 20 is certainly also capable of being used in connection with any other type of substantially horizontally-oriented, non-vehicular structures, now known or later developed.

With respect to materials of construction, because the apparatus 20 is intended to be removably secured to an exhaust pipe 28 (capable of becoming relatively hot) in at least one embodiment, each of the display wall 22, heat wall 24 and at least one support arm 32 is preferably made of sheet metal. However, in further embodiments, the various components of the apparatus 20 may be composed of any other heat-resistant material, or combination of materials, now known or later developed. In still further embodiments where the apparatus 20 is to be removably secured to a horizontally-oriented structure that will not become hot (such as the trailer hitch receiver tube 62), the various components of the apparatus 20 may be composed of any non-heat-resistant material, or combination of materials, now known or later developed, capable of allowing the apparatus 20 to substantially carry out the functionality herein described.

To summarize, regarding the exemplary embodiments of the present invention as shown and described herein, it will be appreciated that a pipe accessory mounting apparatus is disclosed and configured for engagement with a substantially horizontally-oriented pipe (or similar structure) for displaying an ornamental design or the like. Because the principles of the invention may be practiced in a number of configurations beyond those shown and described, it is to be understood that the invention is not in any way limited by the exemplary embodiments, but is generally directed to a pipe accessory mounting apparatus and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A pipe accessory mounting apparatus for removable engagement with a substantially horizontally-oriented pipe, the apparatus comprising:
a display wall;
a heat wall substantially linearly aligned with and spaced a distance apart from the display wall, the heat wall configured for being selectively positioned a distance behind an end of the pipe, in a position between the pipe end and the display wall;
an at least one elongate support arm engaged proximally with each of the heat wall and display wall and configured for being removably secured distally against an outer wall of the pipe; and
a front surface of the display wall, facing substantially away from the pipe end, configured for providing a visual display.

2. The pipe accessory mounting apparatus of claim 1, wherein each of the heat wall and display wall is relatively flat and disc-shaped.

3. The pipe accessory mounting apparatus of claim 1, wherein the distance between the display wall and heat wall is between eight millimeters and twelve millimeters.

4. The pipe accessory mounting apparatus of claim 1, wherein the distance between the pipe opening and the heat wall is at least two inches.

5. The pipe accessory mounting apparatus of claim 1, wherein a diameter of the heat wall is relatively larger than a diameter of the pipe opening.

6. The pipe accessory mounting apparatus of claim 1, wherein each of the heat wall and display wall is substantially vertically-oriented when positioned behind the pipe opening.

7. The pipe accessory mounting apparatus of claim 1, wherein the heat wall is substantially parallel with the display wall.

8. The pipe accessory mounting apparatus of claim 1, wherein the at least one support arm is relatively flexible and capable of bending for selectively adjusting the angle of the heat and display walls, relative to the pipe, as desired.

9. The pipe accessory mounting apparatus of claim 1, wherein a proximal end of each support arm is engaged with a rear surface of each of the heat wall and display wall for rigidly maintaining the spaced-apart distance between the heat wall and display wall.

10. The pipe accessory mounting apparatus of claim 9, wherein an opposing distal end of each support arm extends substantially perpendicularly away from the rear surface of each of the heat wall and display wall and is configured for selectively contacting the outer wall of the pipe;

11. The pipe accessory mounting apparatus of claim 10, further comprising three support arms spaced apart from one another around a perimeter edge of the heat wall.

12. The pipe accessory mounting apparatus of claim 10, further comprising a circumferential clamp configured for removably securing the distal end of the at least one support arm against the outer wall of the pipe.

13. The pipe accessory mounting apparatus of claim 12, wherein the distal end of each support arm provides an angled catch configured for selectively contacting the clamp and preventing the distal end from completely sliding out from under the clamp when engaged about the pipe.

14. The pipe accessory mounting apparatus of claim 1, wherein the display comprises at least one of two-dimensional artwork, three-dimensional artwork, and a lighting display.

15. The pipe accessory mounting apparatus of claim 1, wherein the display comprises a sticker capable of being affixed to the front surface of the display wall.

16. The pipe accessory mounting apparatus of claim 1, wherein the pipe is an exhaust pipe of a vehicle, the pipe end capable of emitting relatively hot exhaust air.

17. The pipe accessory mounting apparatus of claim 1, wherein the pipe is a trailer hitch receiver tube of a vehicle.

18. The pipe accessory mounting apparatus of claim 1, wherein each of the display wall, heat wall and at least one support arm is made of sheet metal.

19. A pipe accessory mounting apparatus for removable engagement with a substantially horizontally-oriented exhaust pipe of a vehicle, the apparatus comprising:
a relatively flat, disc-shaped display wall;
a relatively flat, disc-shaped heat wall substantially linearly aligned with and spaced a distance apart from the display wall, the heat wall configured for being selectively positioned a distance behind an end of the exhaust pipe, in a position between the pipe end and the display wall;
an at least one elongate support arm, a proximal end of each support arm engaged with a rear surface of each of the heat wall and display wall for rigidly maintaining the spaced-apart distance between the heat wall and display wall, an opposing distal end of each support arm extending substantially perpendicularly away from the rear surface of each of the heat wall and display wall and configured for selectively contacting an outer wall of the exhaust pipe;
a circumferential clamp configured for removably securing the distal end of the at least one support arm against the outer wall of the exhaust pipe; and
a front surface of the display wall, opposite the rear surface, providing a display;
whereby, during use, with the apparatus removably engaged with the exhaust pipe, the heat wall is capable of absorbing and deflecting any hot air that may be emitted from the pipe end, thereby allowing the display to remain substantially unaffected by said heat.

20. A method for decorating a substantially horizontally-oriented pipe of a vehicle comprising the steps of:
positioning a pipe accessory mounting apparatus on the pipe such that an at least one support arm of the apparatus contacts an outer wall of the pipe, an opposing end of the at least one support arm being engaged with a rear surface of each of a heat wall and a spaced-apart display wall;
positioning a circumferential clamp over the at least one support arm and outer wall of the pipe, thereby sandwiching the at least one support arm therebetween;
sliding the apparatus along a length of the outer wall of the pipe for selectively positioning the heat wall a distance behind an end of the pipe;
tightening the clamp against the outer wall of the pipe for securing the at least one support arm in place; and
applying a display to a front surface of the display wall, opposite the rear surface thereof.
